(19) United States
(12) Patent Application Publication
(10) Pub. No.: US 2024/0234010 A9
(43) Pub. Date: Jul. 11, 2024

(54) COIL COMPONENT

(71) Applicant: TDK CORPORATION, Tokyo (JP)

(72) Inventors: Hokuto EDA, Tokyo (JP); Masataro SAITO, Tokyo (JP); Kohei TAKAHASHI, Tokyo (JP); Takamasa IWASAKI, Tokyo (JP); Hiroki ASAFUSA, Tokyo (JP); Takahiro NEMOTO, Tokyo (JP)

(73) Assignee: TDK CORPORATION, Tokyo (JP)

(21) Appl. No.: 18/490,293

(22) Filed: Oct. 19, 2023

(30) Foreign Application Priority Data
Oct. 21, 2022 (JP) 2022-168913

(51) Int. Cl. H01F 27/28

(52) U.S. Cl. CPC H01F 27/2852

(57) ABSTRACT

The coil body of the coil component includes a first coil, a second coil, and a third coil arranged in order along one direction when viewed from the facing direction of the pair of main surfaces of the element body. The first coil, the second coil, and the third coil have alternating winding directions, and the number of turns of the second coil is relatively small, thereby improving the characteristics of the coil component.

This application is based upon and claims the benefit of priority from Japanese Patent Application No. 2022-168913, filed on 21 Oct., 2022, the entire contents of which are incorporated herein by reference.

### TECHNICAL FIELD

The present disclosure relates to coil components.

### BACKGROUND

Known in the art is a coil component including a thin film coil used in a power supply circuit. Japanese Patent Publication No. 2017-34227 discloses a thin-film coil having a configuration in which a first coil portion wound in a spiral shape on one surface of a substrate and a second coil portion wound in a spiral shape on the other surface of the substrate are connected via a through-hole conductor provided through the substrate.

### SUMMARY

Although the above-described coil component according to the related art has a configuration in which one thin film coil is included in one component, the inventors have repeatedly studied a configuration in which a plurality of coils connected in series are arranged in one row in one component, and as a result, have newly found a capable of improving characteristics in a configuration of a plurality of coils.

According to the present disclosure, a coil component with improved characteristics is provided.

The coil component includes an element body having a pair of main surfaces facing each other, and a first end surface and a second end surface connecting the pair of main surfaces and parallel to each other, a substrate provided in the element body, extending parallel to the main surface of the element body, and having a first main surface and a second main surface parallel to the main surface of the element body, a coil body provided in the element body and including a plurality of coils each including a first coil portion in a spiral shape provided on the first main surface of the substrate, a second coil portion in a spiral shape provided on the second main surface of the substrate, and a through-hole conductor penetrating the substrate and electrically connecting the first coil portion and the second coil portion, the plurality of coils being connected in series and having one end portion exposed from the first end surface of the element body and the other end portion exposed from the second end surface of the element body, and a first external terminal provided on the first end surface of the element body and connected to one end portion of the coil body, a second external terminal provided on the second end surface of the element body and connected to the other end portion of the coil body, wherein, when viewed from a facing direction of the pair of main surfaces, the plurality of coils of the coil body are arranged along one direction and winding directions of the coils are alternately arranged, and wherein the plurality of coils of the coil body include a first coil located on the first end surface side and connected to one end of the coil body, a second coil located on a side farther from the first end surface than the first coil and having a smaller number of turns than the first coil, and a third coil located on the second end surface side and connected to the other end of the coil body.

In the coil component, the second coil shares flux with the first coil and the third coil located on both sides thereof. The inventors have newly found that characteristics of the coil are improved by relatively reducing the number of turns of the second coil sharing the magnetic fluxes.

In the coil component according to another aspect, the plurality of coils of the coil body are respectively wound around a plurality of through holes provided in the substrate.

In the coil component according to another aspect, the through hole has an elliptical shape having a major axial extending in a direction intersecting a facing direction of the first end surface and the second end surface.

In the coil component according to another aspect, when viewed from the facing direction of the pair of main surfaces, the inner core area of the second coil is larger than the inner core area of the first coil.

In the coil component according to another aspect, when viewed from the facing direction of the pair of main surfaces, the connection portion connecting the coils extends to intersect the imaginary line connecting the axes of the coils.

### BRIEF DESCRIPTION OF THE DRAWINGS

FIG. 1 is a perspective view showing a coil component according to an embodiment.

FIG. 2 is an exploded perspective view of the coil component shown in FIG. 1.

FIG. 3 is an exploded perspective view showing an element body provided in the coil body shown in FIG. 2.

FIG. 4 is a cross-sectional view of the coil shown in FIG. 3.

FIG. 5 is a plan view showing a first coil portion of each coil shown in FIG. 3.

FIG. 6 is a plan view showing a second coil portion of each coil shown in FIG. 3.

FIG. 7 is an exploded perspective view of a coil body of a coil component used for verification.

FIG. 8 is a plan view showing a first coil portion of each coil shown in FIG. 7.

FIG. 9 is a plan view showing a second coil portion of each coil shown in FIG. 7.

FIG. 10 is a diagram showing a verification result of the coil component having the configuration of FIGS. 7 to 9.

FIG. 11 is a diagram illustrating a verification result of the coil component having the configuration of FIGS. 1 to 6.

### DETAILED DESCRIPTION

Hereinafter, embodiments for carrying out the present disclosure will be described with reference to the accompanying drawings. In the description of the drawings, the same or equivalent elements are denoted by the same reference numerals, and redundant description is omitted.

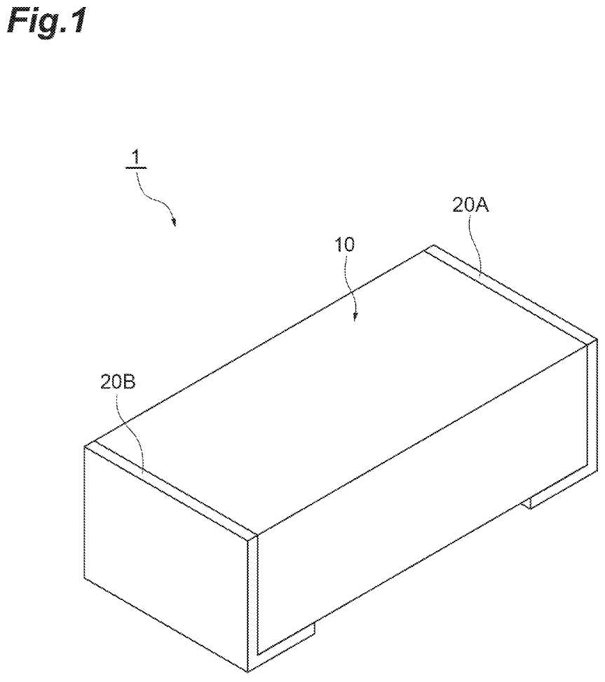

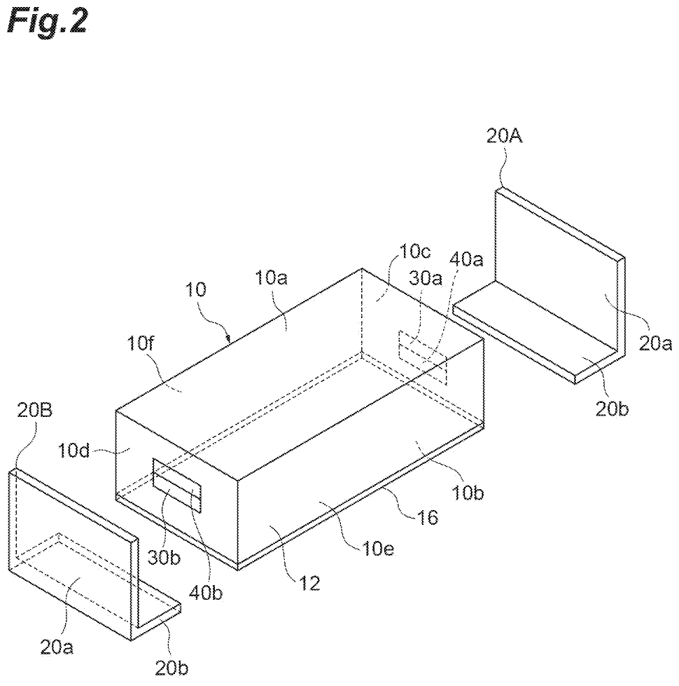

A coil component 1 according to one embodiment will be described with reference to FIGS. 1 to 6. As shown in FIGS. 1 and 2, the coil component 1 includes an element body 10 and a pair of external terminals 20A and 20B provided on the surfaces of the element body 10.

The element body 10 has a substantially rectangular parallelepiped outer shape, and includes a pair of a main surfaces 10a and 10b facing each other, a pair of end surfaces 10c and 10d facing each other, and a pair of side surfaces 10e and 10f facing each other. The pair of end surfaces 10c and 10d and the pair of side surfaces 10e and 10f connect the pair of the main surfaces 10a and 10b. In the present embodiment, the facing direction of the pair of the main surface 10a and 10b is the height direction of the element body 10, the facing direction of the pair of end surfaces 10c and 10d is the long side direction of the element body 10, and the facing direction of the pair of side surfaces 10e and 10f is the short side direction of the element body 10. In the present embodiment, the main surface 10b serves as a mounting surface facing the base substance on which the coil component 1 is mounted. As an example, the coil component 1 is designed to have dimensions of long side 2.0 mm, short side 1.25 mm, and height 1.0 mm.

Of the pair of the external terminals 20A and 20B, the first external terminal 20A is provided on the end surface 10c side of the element body 10. The first external terminal 20A includes a portion 20a covering the end surface 10c and a portion 20b covering a part of the main surface 10b on the end surface 10c side, and has an L-shaped cross section continuously covering the end surface 10c and the main surface 10b. Of the pair of the external terminal 20A and 20B, the second external terminal 20B is provided on the end surface 10d side of the element body 10. Like the first external terminal 20A, the second external terminal 20B includes a portion 20a covering the end surface 10d and a portion 20b covering a part of the main surface 10b on the end surface 10d side, and has an L-shaped cross section continuously covering the end surface 10d and the main surface 10b.

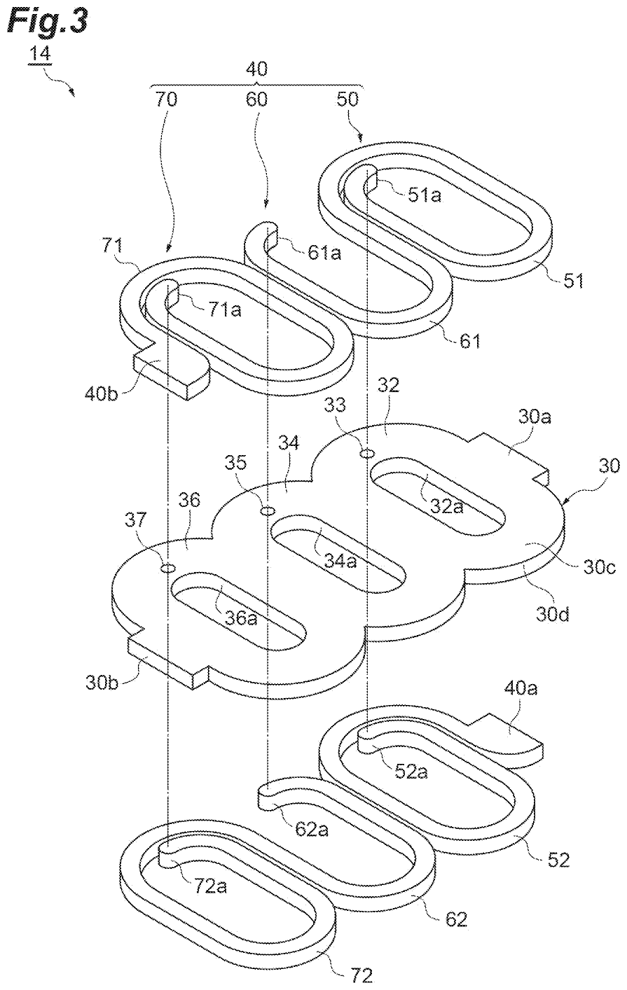

The element body 10 has a configuration in which the coil structure 14 shown in FIG. 3 is provided inside the magnetic material 12. Magnetic powder-containing resin can be used for the magnetic material 12 constituting the element body 10. The magnetic powder-containing resin has a configuration in which magnetic powder such as metal magnetic powder or ferrite powder is dispersed in the resin. The magnetic powder-containing resin may contain both a metal magnetic powder and a ferrite powder as magnetic powder. The metal magnetic powder may be composed of, for example, an iron-nickel alloy (permalloy), carbonyl iron, an amorphous, FeSiCr alloy in amorphous or crystalline state, sendust, or the like. The resin used in the magnetic powder-containing resin is, for example, a thermosetting epoxy resin. The content of the magnetic powder contained in the magnetic powder-containing resin is, for example, 90 to 99 wt %. In the present embodiment, only the main surface 10b of the element body 10 is constituted by the insulating layer 16 constituted by an insulating material such as an insulating resin (for example, epoxy resin) instead of the magnetic powder-containing resin. In the main surface 10b, the portions 20b of the pair of the external terminals 20A and 20B are close to each other, but by the insulating layer 16, the withstand voltage between the pair of the external terminals 20A and 20B in the main surface 10b is improved. In addition, in the main surface 10b, since the insulating material of the insulating layer 16 is interposed between each the external terminals 20A and 20B and the magnetic powder-containing resin (that is, each the external terminals 20A and 20B are not in direct contact with the magnetic powder-containing resin), the stray capacitance is also reduced. The element body 10 may have a configuration in which the insulating layer 16 is not included, or may be configured by only the magnetic powder-containing resin.

The coil structure 14 includes a substrate 30 and a coil body 40.

The substrate 30 extends between a pair of end surfaces 10c and 10d of the element body 10 and has end portions 30a and 30b exposed from each end surface 10c and 10d. The substrate 30 has a planar shape extending parallel to the main surfaces 10a and 10b of the element body and has an upper surface 30c (first main surface) located on the main surface 10a side and a lower surface 30d (second main surface) located on the main surface 10b side. The substrate 30 has a first portion 32 corresponding to a first coil 50, a second portion 34 corresponding to a second coil 60, and a third portion 36 corresponding to a third coil 70, which will be described later. In the first portion 32, the second portion 34, and the third portion 36, there are provided through holes 32a, 34a, and 36a, respectively. Each of the through holes 32a, 34a, 36a has an elliptical shape, more specifically an elliptical shape having major axes extending along the short side direction of the element body 10 (i.e., the direction orthogonal to the facing direction of the end surfaces 10c and 10d). In the present embodiment, the substrate 30 has a chain-like shape when viewed from the main surface 10a side of the element body 10.

The substrate 30 is made of a nonmagnetic insulating material. As the substrate 30, substrate obtained by impregnating a glass cloth with cyanate resin (registered trademark) can be used. In addition to the BT resin, polyimide, aramid, or the like can be used. Ceramic or glass can also be used as the material of the substrate 30. As the material of the substrate 30, a mass-produced printed substrate material can be used, and a resin material used for BT-printed substrate, FR4 printed substrate, or FR5 printed substrate can be used.

The coil body 40 includes a plurality of coils arranged in the long side direction of the element body 10, and includes three coils of the first coil 50, the second coil 60, and the third coil 70 in the present embodiment. A plurality of coils included in the coil body 40 are connected in series, and in the present embodiment, the first coil 50, the second coil 60, and the third coil 70 are connected in series in this order. One end portion 40a of the coil body 40 is exposed to the end surface 10c of the element body 10 on the lower surface 30d of the substrate 30 and connected to the first external terminal 20A. The other end portion 40b of the coil body 40 is exposed to the end surface 10d of the element body 10 on the upper surface 30c of the substrate 30 and connected to the second external terminal 20B.

Each the coils 50, 60, and 70 included in the coil body 40 has a first coil portion 51, 61, and 71 in a spiral shape provided on the upper surface 30c of the substrate 30, a second coil portion 52, 62, and 72 in a spiral shape provided on the lower surface 30d of the substrate 30, and through-hole conductors 33, 35, and 37 penetrating the substrate 30 and electrically connecting the first coil portion 51, 61, and 71 and the second coil portion 52, 62, and 72.

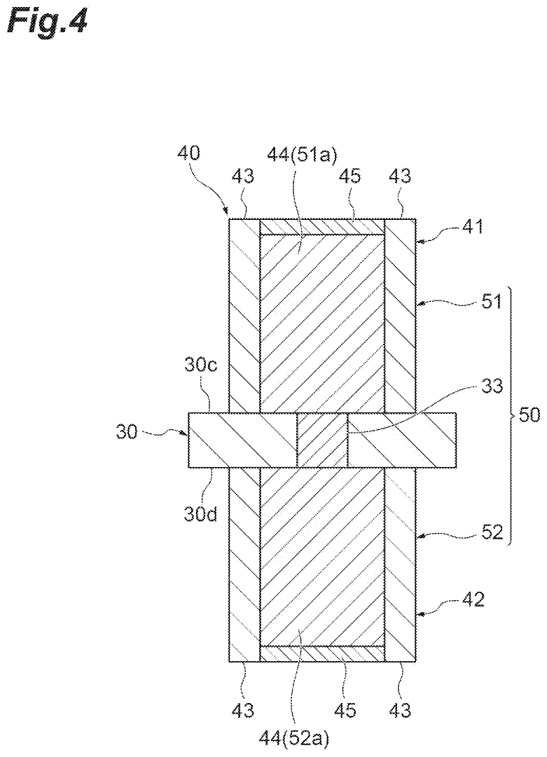

As shown in FIG. 4, resin bodies 41 and 42 are provided on the upper surface 30c and the lower surface 30d of the substrate 30, respectively, and regions of conductors 44 constituting the coil body 40 are defined by resin walls 43 of the resin bodies 41 and 42. Each the resin bodies 41 and 42 is made of a nonmagnetic resin material and is a thick-film resist patterned by known photolithography. With respect to the size of the resin wall 43, for example, the outermost the resin wall 43 can be designed to be 20 μm in width. The conductor 44 of the coil body 40 may be plated with the resin wall 43 of each the resin bodies 41 and 42 defining a growth region. In the present embodiment, the cross-sectional dimensions (for example, widths and heights in a rectangular cross-section) of the conductors 44 constituting the coil body 40 are substantially uniform over the entire length of the coil body. The cross-sectional dimensions of the conductor 44 are, for example, 175 μm in height and 80 μm in width. An insulating coating 45 is provided on the surfaces of the conductors 44 to insulate the conductors 44 from the magnetic powder-containing resin constituting the element body 10.

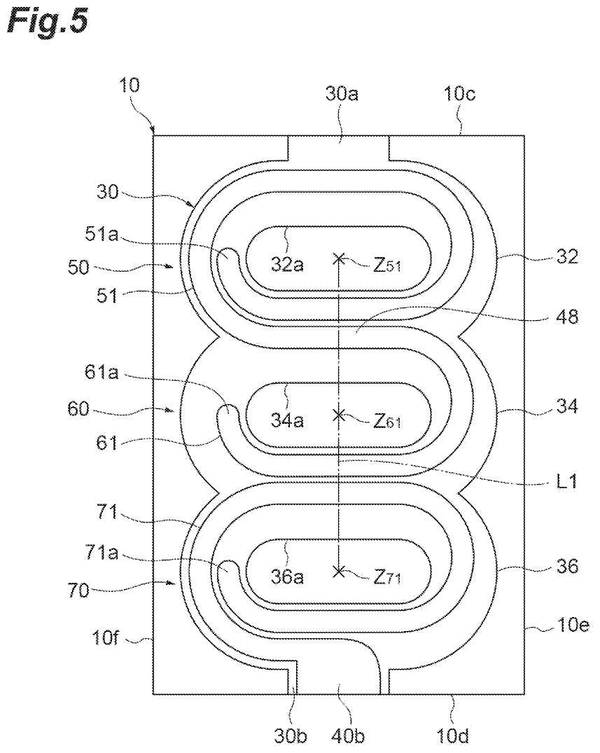

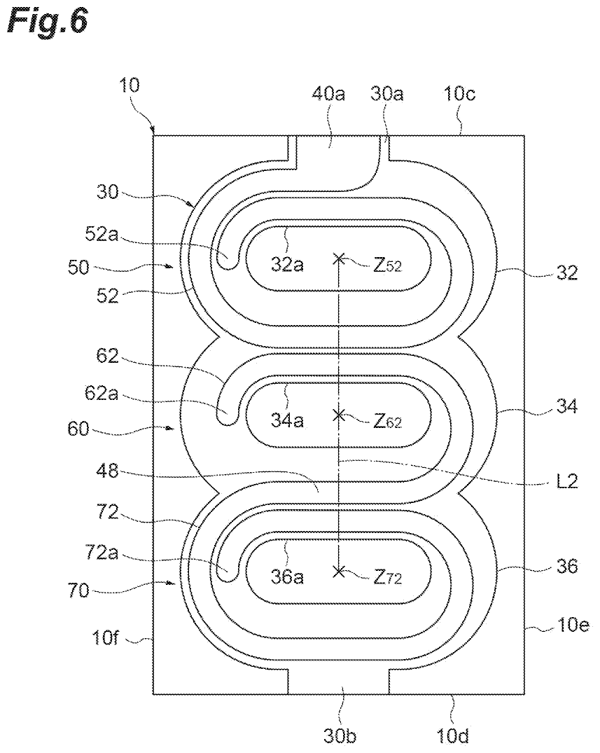

Next, the configurations of the first coil 50, the second coil 60, and the third coil 70 will be described in more detail with reference to FIGS. 5 and 6. FIGS. 5 and 6 show the positional relationship among the substrate 30, the first coil 50, the second coil 60, and the third coil 70 when viewed from the main surface 10a side of the element body 10.

The first coil 50 is located on the end surface 10c (first end surface) side of the element body 10, and is connected to one end portion 40a of the coil body 40. As shown in FIG. 5, the first coil portion 51 of the first coil 50 is a conductor pattern of a planar in a spiral shape of a single layer structure wound by about 5/4 turns around a coil axis Zsi. The first coil portion 51 is wound counterclockwise from the inner periphery turn toward the outer periphery turn. An inner end portion 51a of the first coil portion 51 is connected to the through-hole conductor 33 provided through the substrate 30 in a portion overlapping the inner end portion 51a. The outer end portion of the first coil portion 51 extends toward the end surface 10d side of the element body 10 and is connected to the first coil portion 61 of the second coil 60. The first coil portion 32 of the substrate 30, which overlaps the first coil portion 51, has a substantially annular shape and has the through hole 32a through which the coil axis Z₅₁ of the first coil portion 51 passes. The inner end portion 51a of the first coil portion 51 is located at the through hole 32a edge of the first portion 32.

The second coil 60 is located between the first coil 50 and the third coil 70. As shown in FIG. 5, the first coil portion 61 of the second coil 60 is a conductor pattern of a planar in a spiral shape having one-layer structure wound around a coil axis Z₆₁ by about 3/4 turn. The first coil portion 61 is wound in the opposite direction (i.e., clockwise) to the first coil portion 51 of the first coil 50. One end portion of the first coil portion 61 extends toward the end surface 10c side of the element body 10 and is connected to the first coil portion 51 of the first coil 50. A connection portion 48

Where the first coil portion 51 and the first coil portion 61 are connected to each other extends to intersect an imaginary line L1 connecting both coil axes Z₅₁ and Z₆₁. The other end portion 61a of the first coil portion 61 is connected to a through-hole conductor 35 provided through the substrate 30 in a portion overlapping the other end portion 61a. The second portion 34 of the substrate 30 overlapping with the second portion 61 has a substantially annular shape, and has a through hole 34a through which the coil axis Z₆₁ of the first coil portion 61 passes. The other end portion 61a of the first coil portion 61 is located at the edge of the through hole 34a of the second portion 34.

The third coil 70 is located on the end surface 10d (second end surface) side of the element body 10, and is connected to the other end portion 40b of the coil body 40. As shown in FIG. 5, the first coil portion 61 of the second coil 60 is a conductor pattern of a planar in a spiral shape having a single-layer structure wound by about 5/4 turns around the coil axis Z₆₁. The first coil portion 71 is wound counterclockwise from the inner periphery turn toward the outer periphery turn. An outer end portion of the first coil portion 71 is connected to an end portion 40b of the coil body 40, and an inner end portion 71a of the first coil portion 71 is connected to a through-hole conductor 37 provided through the substrate of a portion overlapping the inner end portion 71a. The third portion 36 of the substrate 30 overlapping with the third portion 71 has a substantially annular shape, and has a through hole 36a through which a coil axis Z₇₁ of the first coil portion 71 passes. The inner end portion 71a of the first coil 71 is located at the through hole 36a edge of the third portion 36.

On the upper surface 30c of the substrate 30, the first coil portion 51 of the first coil 50 is connected to the first coil portion 61 of the second coil 60, and the first coil portion 71 of the third coil 70 is spaced apart. The number of turns of the first coil portion 61 of the second coil 60 is less than the number of turns of the first coil portion 51 of the first coil 50 and less than the number of turns of the first coil portion 71 of the third coil 70. The number of turns of the first coil portion 51 of the first coil 50 may be equal to or different from the number of turns of the first coil portion 71 of the third coil 70. The first coil portion 51 of the first coil 50, the first coil portion 61 of the second coil 60, and the first coil portion 71 of the third coil 70 are designed to have equal conductor widths. In the present embodiment, the coil axis Z₅₁ of the first coil portion 51, the coil axis Z₆₁ of the first coil portion 61, and the coil axis Z₇₁ of the first coil portion 71 are aligned in the long side direction of the element body 10 (that is, the facing direction of the end surfaces 10c and 10d).

As shown in FIG. 6, the second coil portion 52 of the first coil 50 is a conductor pattern of a planar in a spiral shape having one-layer structure wound around a coil axis Z₅₂ by about 5/4 turns. In the present embodiment, the coil axis Z₅₂ of the second coil portion 52 coincides with the coil axis Z₅₁ of the first coil portion 51. The second coil portion 52 is wound counterclockwise from the outer periphery turn toward the inner periphery turn. Therefore, in the first coil portion 51 and the second coil portion 52 of the first coil 50, when viewed from the main surface 10a side of the element body 10, current flows in the same winding direction when current flows. An outer end of the second coil portion 52 is connected to the end portion 40a of the coil body 40, and an inner end portion 52a of the second coil portion 52 is positioned to overlap the through-hole conductor 33 in the lower surface 30d of the substrate 30 and is connected to the through-hole conductor 33.

The second coil portion 62 of the second coil 60 is a single-layer planar in a spiral shape conductor pattern wound about 3/4 turns around a coil axis Z₆₂. In the present embodiment, the coil axis Z₆₂ of the second coil portion 62 coincides with the coil axis Z₆₁ of the first coil portion 61. The second coil portion 62 is wound in the opposite direction (i.e., clockwise) to the second coil portion 52 of the first coil 50. Therefore, in the first coil portion 61 and the second coil portion 62 of the second coil 60, when viewed from the main surface 10a side of the element body 10, current flows in the same winding direction when current flows. One end portion 62a of the second coil portion 62 is located at a position overlapping with the through-hole conductor 35 in the lower surface 30d of the substrate 30 and is connected to the through-hole conductor 35. The other end portion of the second coil portion 62 extends toward the end surface 10d side of the element body 10 and is connected to the second coil portion 72 of the third coil 70.

The second coil portion 72 of the third coil 70 is a single-layer planar in a spiral shape conductor pattern wound about 5/4 turns around a coil axis Z₇₂. In the present embodiment, the coil axis Z₇₂ of the second coil portion 72 coincides with the coil axis Z₇₁ of the first coil portion 71. The second coil portion 72 is wound counterclockwise from the outer periphery turn toward the inner periphery turn. Therefore, in the first coil portion 71 and the second coil portion 72 of the third coil 70, when viewed from the main surface 10a side of the element body 10, current flows in the same winding direction when current flows. An inner end portion 72a of the second coil portion 72 is located at a position overlapping with the through-hole conductor 37 in the lower surface 30d of the substrate 30 and is connected to the through-hole conductor 37. An outer end portion of the second coil portion 72 extends toward the end surface 10c side of the element body 10 and is connected to the outer end portion of the second coil portion 62 of the second coil 60. The connection portion 48 in which the second coil portion 62 and the second coil portion 72 are connected to each other extends to intersect an imaginary line L2 connecting both coil axes Z₆₂ and Z₇₂.

On the lower surface 30d of the substrate 30, the second coil portion 52 of the first coil 50 and the second coil portion 62 of the second coil 60 coil are spaced apart from each other, and the second coil portion 62 of the second coil 60 and the second coil portion 72 of the third coil 70 are connected to each other. The number of turns of the second coil portion 62 of the second coil 60 is less than the number of turns of the second coil portion 52 of the first coil 50 and less than the number of turns of the second coil portion 72 of the third coil 70. The number of turns of the second coil portion 52 of the first coil 50 may be the same as or different from the number of turns of the second coil portion 72 of the third coil 70. The second coil portion 52 of the first coil 50, the second coil portion 62 of the second coil 60, and the second coil portion 72 of the third coil 70 are designed to have the same conductor widths. In the present embodiment, the coil axis Z₅₂ of the second coil portion 52, the coil axis Z₆₂ of the second coil portion 62, and the coil axis Z₇₂ of the second coil portion 72 are aligned in the long side direction of the element body 10 (that is, the facing direction of the end surfaces 10c and 10d).

Since the coil body 40 has the above configuration, when a voltage is applied between a pair of the external terminals 20A and 20B and a current flows from the first external terminal 20A to the second external terminal 20B, for example, the current from the first external terminal 20A flows through the first coil 50, the second coil 60, and the third coil 70 of the coil body 40 in this order to reach the second external terminal 20B. When the current flows in this manner, since the winding directions of the first coil 50, the second coil 60, and the third coil 70 alternate when viewed from the main surface 10a side of the element body 10, the second coil 60 located in the middle shares magnetic fluxes with the first coil 50 and the third coil 70 on both sides thereof. That is, with respect to the direction of the magnetic fluxes in the facing direction of the main surfaces 10a and 10b of the element body 10, the direction of the magnetic fluxes on the inner side (inner core) of the second coil 60 is the same as the direction of the magnetic fluxes on the outer side (outer core) of the first coil 50 and the third coil 70. As a result, the flux in the inner core of the second coil 60 tends to be greater than the flux in the inner core of the first coil 50 and third coil 70.

Here, the number of turns of the second coil 60 is about 3/2 in total of the number of turns of the first coil portion 61 (3/4 turns) and the number of turns of the second coil portion 62 (3/4 turns), and is smaller than the number of turns of the first coil 50 (5/2, that is, the sum of the number of turns of the first coil portion 51 (5/4 turns) and the number of turns of the second coil portion 52 (5/4 turns)). Similarly, the number of turns of the second coil 60 is smaller than the number of turns of the third coil 70 (5/2, that is, the sum of the number of turns of the first coil portion 71 (5/4 turns) and the number of turns of the second coil portion 72 (5/4 turns)). The number of turns of the first coil 50 may be the same as or different from the number of turns of the third coil 70.

The inventors have found that when the number of turns of the second coil 60 that shares flux with the first coil 50 and the third coil 70 at both sides is relatively reduced, the characteristics of the coil component 1 are improved as in the following validation tests.

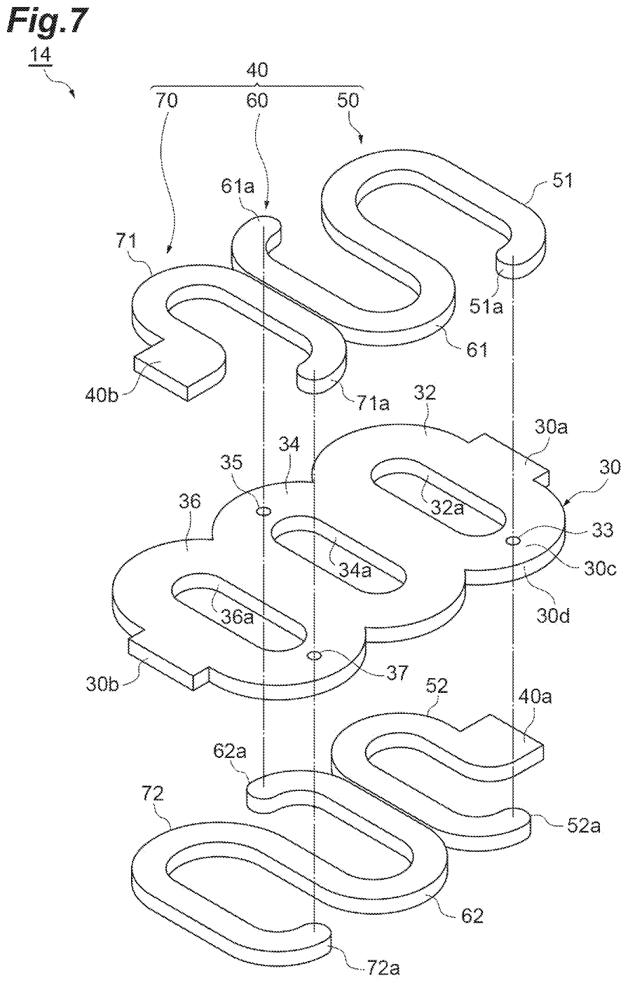

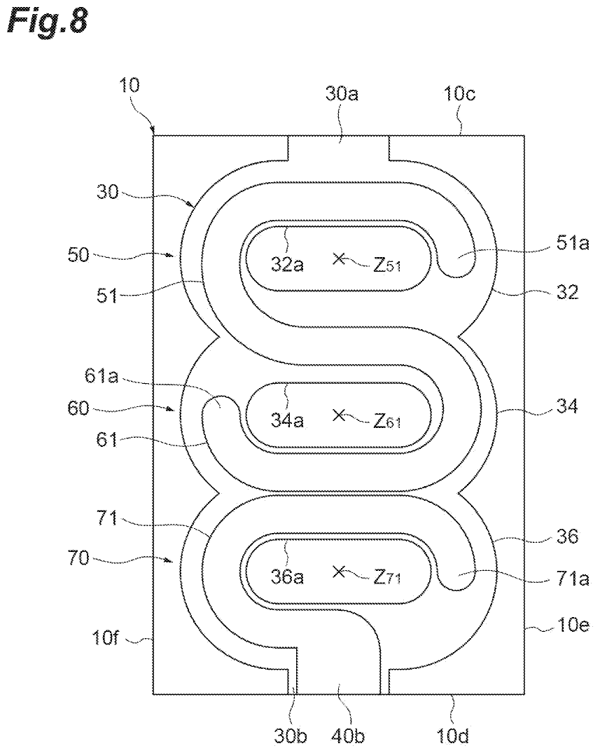

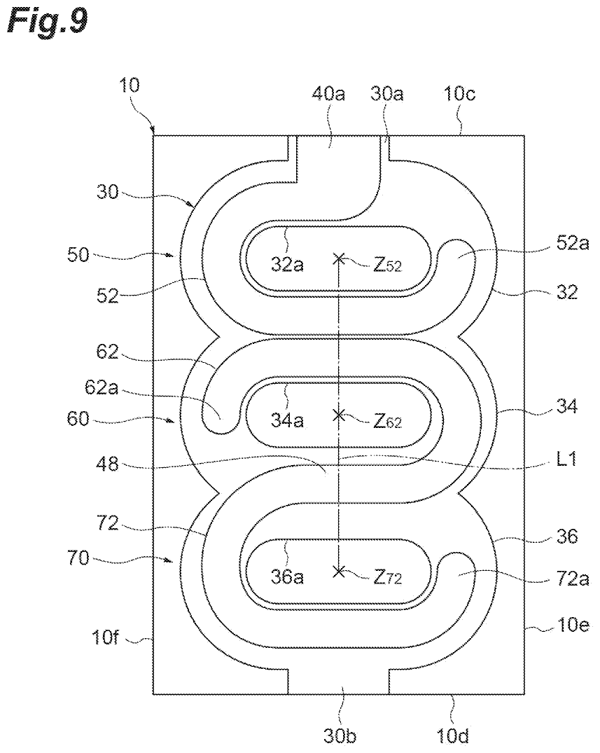

FIGS. 7 to 9 show the configuration of the coil component used in the verification test. The coil component illustrated in FIGS. 7 to 9 is different from the above-described coil component mainly in the number of turns of each the coils 50, 60, and 70, and other elements are identical or equivalent. To be specific, the number of turns of the second coil 60 is about 3/2 in total of the number of turns of the first coil portion 61 (3/4 turns) and the number of turns of the second coil portion 62 (3/4 turns), which is the same as the number of turns of the first coil 50 (3/2, that is, the sum of the number of turns of the first coil portion 51 (3/4 turns) and the number of turns of the second coil portion 52 (3/4 turns)). Similarly, the number of turns of the second coil 60 is equal to the number of turns of the third coil 70 (3/2, that is, the sum of the number of turns of the first coil portion 71 (3/4 turns) and the number of turns of the second coil portion 72 (3/4 turns)).

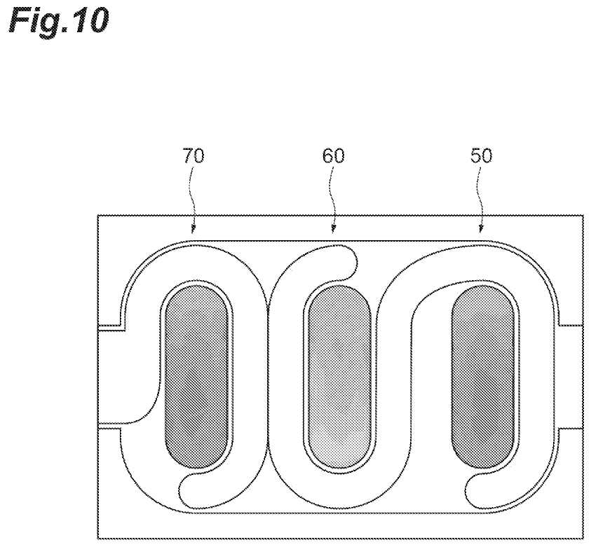

When the magnetic flux density distribution of the coil component having the form shown in FIGS. 7 to 9 was confirmed, the result was as shown in FIG. 10. The magnetic-flux density distribution was confirmed by frequency-response magnetic-field analysis using electromagnetic-field analysis software (Ansys Electronics Desktop Maxwell 3D) under conditions of a frequency of 1 MHz and a current of 0.1A. In FIG. 10, the lower the magnetic flux density magnetic flux density is lower, and the density is lower as the magnetic flux density is higher (that is, the color becomes closer to white). From the results of FIG. 10, it was confirmed that the flux density in the inner core of the second coil 60 was higher than the flux densities in the inner cores of the first coil 50 and the third coil 70.

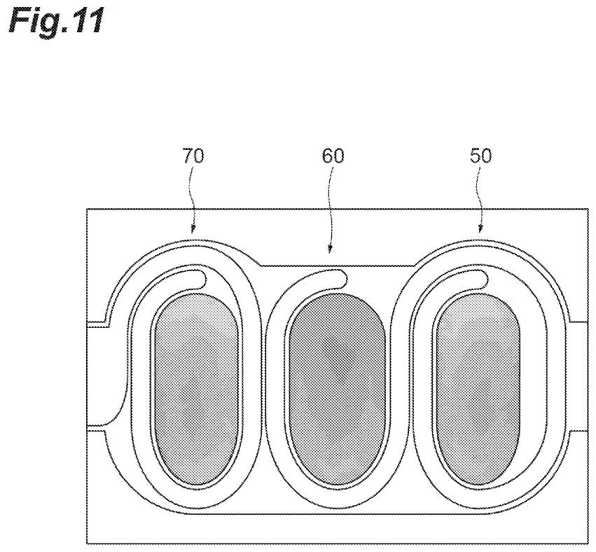

The magnetic flux density distribution of the coil component 1 having the configuration shown in FIGS. 1 to 6 was similarly confirmed, and the result was as shown in FIG. 11. From the results of FIG. 11, it was confirmed that the flux density in the inner core of the second coil 60 was substantially equal to the flux density in the inner core of each of the first coil 50 and the third coil 70.

In this manner, local concentration (or deviation) of the magnetic flux densities among the plurality of the coils 50, 60, and 70 constituting the coil body 40 is suppressed, and thus coil characteristics such as DC superposition characteristics are improved.

The second coil 60 having a relatively small number of turns may have inner core area (area inside the coil when viewed from the facing direction of the main surfaces 10a and 10b) larger than the inner core areas of the first coil 50 and the third coil 70. The inner core areas of the coils 50, 60, and 70 may be the same.

The present disclosure is not necessarily limited to the above-described embodiment, and various modifications can be made without departing from the scope of the present disclosure. For example, the number of coils included in the coil body is not limited to three, and may be four or more. In addition, the number of turns and the line widths may be different between the first coil portion and the second coil portion of each coil. The through hole provided in the substrate may have an elliptical shape having a long axis extending obliquely with respect to a short side direction of the substrate.

What is claimed is:

1. A coil component comprising:
an element body having a pair of main surfaces facing each other, and a first end surface and a second end surface connecting the pair of main surfaces and parallel to each other;
a substrate provided in the element body, extending parallel to the main surface of the element body, and having a first main surface and a second main surface parallel to the main surface of the element body;
a coil body provided in the element body and including a plurality of coils each including a first coil portion in a spiral shape provided on the first main surface of the substrate, a second coil portion in a spiral shape provided on the second main surface of the substrate, and a through-hole conductor penetrating the substrate and electrically connecting the first coil portion and the second coil portion, the plurality of coils being connected in series and having one end portion exposed from the first end surface of the element body and the other end portion exposed from the second end surface of the element body; and
a first external terminal provided on the first end surface of the element body and connected to one end portion of the coil body;
a second external terminal provided on the second end surface of the element body and connected to the other end portion of the coil body,
wherein, when viewed from a facing direction of the pair of main surfaces, the plurality of coils of the coil body are arranged along one direction and winding directions of the coils are alternately arranged, and
wherein the plurality of coils of the coil body include a first coil located on the first end surface side and connected to one end of the coil body, a second coil located on a side farther from the first end surface than the first coil and having a smaller number of turns than the first coil, and a third coil located on the second end surface side and connected to the other end of the coil body.

2. The coil component according to claim 1, wherein the plurality of coils of the coil body are respectively wound around a plurality of through holes provided in the substrate.

3. The coil component according to claim 2, wherein the through hole has an elliptical shape having a long axis extending in a direction intersecting a facing direction of the first end surface and the second end surface.

4. The coil component according to claim 1, wherein inner core area of the second coil is larger than inner core area of the first coil when viewed from a facing direction of the pair of main surfaces.

5. The coil component according to claim 1, wherein, when viewed from a facing direction of the pair of main surfaces, a connection portion connecting the coils extends to intersect an imaginary line connecting axes of both coils.
